(19) United States
(12) Patent Application Publication
(10) Pub. No.: US 2024/0241297 A1
(43) Pub. Date: Jul. 18, 2024

(54) MULTI-SPECTRAL FILTER

(71) Applicant: SAFRAN ELECTRONICS & DEFENSE, Paris (FR)

(72) Inventor: Arnaud DAVENEL, Moissy-Cramayel (FR)

(73) Assignee: SAFRAN ELECTRONICS & DEFENSE, Paris (FR)

(21) Appl. No.: 18/559,404

(22) PCT Filed: May 5, 2022
(86) PCT No.: PCT/FR2022/050866

§ 371 Date: Nov. 7, 2023

(30) Foreign Application Priority Data
May 11, 2021 (FR) 2104978

(51) Int. Cl. G02B 5/20

(52) U.S. Cl. CPC G02B 5/201

(57) ABSTRACT

A multispectral filter with a filtering array for a sensor with an array of elementary sensors, said filtering array comprising an elementary pattern formed of an arrangement of N elementary cells capable of filtering central wavelengths λ1, . . . , λk, . . . , λN, the position of the central wavelengths in the elementary pattern being determined so that: each wavelength being associated with an integer e1, . . . , ek, . . . , eN, selected so that each of the products e1x λ1, . . . , ekx λk, . . . , eNx λN is substantially constant, each central wavelength λk is positioned at ek positions in the elementary pattern so that the maximum ratio between the distance between two proximal positions of said central wavelength and the associated central wavelength is minimal.

### TECHNICAL FIELD OF THE INVENTION

The invention relates to the field of multispectral imaging, in particular the invention relates to a method for configuring a multispectral filter for a multispectral sensor and the definition of its structure.

### PRIOR ART

An image sensor is composed of a plurality of photosites arranged into a grid over the entire surface of the sensors. The photosites capture the intensity of the light to which they are exposed without distinction of the wavelengths of the light and therefore of the colors. To distinguish colors by the image sensor, a multispectral filter is placed on the sensor. The multispectral filter filters at each photosite one single wavelength range, conventionally characterized by its so-called average or central wavelength.

Thus, the filter allows detecting one single color for each photosite, which color corresponds to the spectral integration of the received flux passing through the filter with the spectral transmission of the filter specifically placed on said photosite, and corresponds to the average or central wavelength of said filter. A subsequent image processing of the data acquired by the photosites allows reconstructing a multicolor image of an observed scene.

Current multispectral filters are characterized by an elementary pattern consisting of a number of photosites close to the number of wavelength ranges to be detected. For example, the Bayer filter, called the RGB filter, consists of a 2*2 elementary pattern having two photosites detecting the green color, one photosite detecting the red color and one photosite detecting the blue color. Each photosite detects only one color, the optronic chain downstream of the sensor should interpolate for each photosite the two remaining colors which have not been detected. This step is called demosaicing or debayering. For multispectral applications, there are filters having a 3 times 3 elementary pattern allowing detecting a larger number of spectral bands, namely nine. However, this filter type could cause problems during the debayering step, leading to a non-constant image quality for the nine colors. Indeed, a sampling problem related to the point spread function (PSF) appears, said response itself being related by diffraction phenomena to the wavelength and the aperture number. Thus, this type of multispectral filters does not take into account the sampling capabilities of the sensor with regards to the diffraction of the optical system at the photosites, which reduces the accuracy and fidelity of the complete optronic chain optics-sensor-demosaicing. This type of multispectral filters does not take into account the sampling capabilities of the sensor with regards to the diffraction of the optical system at the photosites, which reduces the accuracy and fidelity of the complete optronic chain optics-sensor-demosaicing.

The present disclosure aims to overcome these drawbacks.

### SUMMARY OF THE INVENTION

To this end, the present disclosure relates to a multispectral filter with a filtering array for a sensor with an array of elementary sensors or photosites, said filtering array comprising an elementary pattern formed of an arrangement of N elementary cells capable of filtering central wavelengths λ₁, . . . , λₖ, . . . , λ_{N}, the position of the elementary cells sensitive to the central wavelengths in the elementary pattern being determined so that: each wavelength being associated with an integer e₁, . . . , eₖ, . . . , e_{N}, selected so that each of the products e₁x λ₁, . . . , eₖx λₖ, . . . , e_{N}x λ_{N} is substantially constant, each elementary cell sensitive to the central wavelength λₖ, is positioned at eₖ positions in the elementary pattern so that the maximum ratio between the distance between two proximal positions of the elementary cell sensitive to said central wavelength and the associated central wavelength is minimal.

The associated central wavelength of a cell may correspond to the weighted barycenter of the wavelengths by the spectral transmission of the considered filter, so-called “at the central wavelength.”. In other words, the wavelengths are weighted by the spectral transmissions at the considered wavelengths.

In particular, the associated central wavelength of a cell may be determined according to the following formula:

$$\frac{{Σ}_{1}^{n} {λ}_{i} * {transmission}_{{λ}_{k}}}{{Σ}_{1}^{n} {transmission}_{{λ}_{k}}}$$

with transmission_{λ}_{ₖ} being the spectral transmission of the associated central wave λₖ. The elementary pattern may be as follows:

$$\begin{matrix}{λ}_{9} \pm Δ {λ}_{9} & {λ}_{3} \pm Δ {λ}_{3} & {λ}_{6} \pm Δ {λ}_{6} & {λ}_{8} \pm Δ {λ}_{8} & {λ}_{3} \pm Δ {λ}_{3} & {λ}_{7} \pm Δ {λ}_{7} & {λ}_{9} \pm Δ {λ}_{9} & {λ}_{4} \pm Δ {λ}_{4} & {λ}_{7} \pm Δ {λ}_{7} \\ {λ}_{1} \pm Δ {λ}_{1} & {λ}_{5} \pm Δ {λ}_{5} & {λ}_{9} \pm Δ {λ}_{9} & {λ}_{6} \pm Δ {λ}_{6} & {λ}_{5} \pm Δ {λ}_{5} & {λ}_{8} \pm Δ {λ}_{8} & {λ}_{1} \pm Δ {λ}_{1} & {λ}_{5} \pm Δ {λ}_{5} & {λ}_{8} \pm Δ {λ}_{8} \\ {λ}_{2} \pm Δ {λ}_{2} & {λ}_{8} \pm Δ {λ}_{8} & {λ}_{6} \pm Δ {λ}_{6} & {λ}_{4} \pm Δ {λ}_{4} & {λ}_{4} \pm Δ {λ}_{4} & {λ}_{2} \pm Δ {λ}_{2} & {λ}_{6} \pm Δ {λ}_{6} & {λ}_{3} \pm Δ {λ}_{3} & {λ}_{6} \pm Δ {λ}_{6} \\ {λ}_{9} \pm Δ {λ}_{9} & {λ}_{7} \pm Δ {λ}_{7} & {λ}_{3} \pm Δ {λ}_{3} & {λ}_{8} \pm Δ {λ}_{8} & {λ}_{1} \pm Δ {λ}_{1} & {λ}_{7} \pm Δ {λ}_{7} & {λ}_{9} \pm Δ {λ}_{9} & {λ}_{7} \pm Δ {λ}_{7} & {λ}_{4} \pm Δ {λ}_{4} \\ {λ}_{4} \pm Δ {λ}_{4} & {λ}_{5} \pm Δ {λ}_{5} & {λ}_{9} \pm Δ {λ}_{9} & {λ}_{6} \pm Δ {λ}_{6} & {λ}_{5} \pm Δ {λ}_{5} & {λ}_{8} \pm Δ {λ}_{8} & {λ}_{6} \pm Δ {λ}_{6} & {λ}_{5} \pm Δ {λ}_{5} & {λ}_{8} \pm Δ {λ}_{8} \\ {λ}_{6} \pm Δ {λ}_{6} & {λ}_{8} \pm Δ {λ}_{8} & {λ}_{2} \pm Δ {λ}_{2} & {λ}_{4} \pm Δ {λ}_{4} & {λ}_{9} \pm Δ {λ}_{9} & {λ}_{3} \pm Δ {λ}_{3} & {λ}_{2} \pm Δ {λ}_{2} & {λ}_{1} \pm Δ {λ}_{1} & {λ}_{4} \pm Δ {λ}_{4} \\ {λ}_{9} \pm Δ {λ}_{9} & {λ}_{3} \pm Δ {λ}_{3} & {λ}_{1} \pm Δ {λ}_{1} & {λ}_{8} \pm Δ {λ}_{8} & {λ}_{6} \pm Δ {λ}_{6} & {λ}_{7} \pm Δ {λ}_{7} & {λ}_{9} \pm Δ {λ}_{9} & {λ}_{7} \pm Δ {λ}_{7} & {λ}_{7} \pm Δ {λ}_{7} \\ {λ}_{7} \pm Δ {λ}_{7} & {λ}_{5} \pm Δ {λ}_{5} & {λ}_{9} \pm Δ {λ}_{9} & {λ}_{6} \pm Δ {λ}_{6} & {λ}_{5} \pm Δ {λ}_{5} & {λ}_{8} \pm Δ {λ}_{8} & {λ}_{4} \pm Δ {λ}_{4} & {λ}_{5} \pm Δ {λ}_{5} & {λ}_{8} \pm Δ {λ}_{8} \\ {λ}_{6} \pm Δ {λ}_{6} & {λ}_{8} \pm Δ {λ}_{8} & {λ}_{4} \pm Δ {λ}_{4} & {λ}_{2} \pm Δ {λ}_{2} & {λ}_{9} \pm Δ {λ}_{9} & {λ}_{1} \pm Δ {λ}_{1} & {λ}_{6} \pm Δ {λ}_{6} & {λ}_{3} \pm Δ {λ}_{3} & {λ}_{2} \pm Δ {λ}_{2}\end{matrix}$$

With the wavelengths {λ₁-λ₉} being the following series {1,100; 917; 786; 688; 611; 550; 500; 458; 423}, and Δλₖ being a predetermined wavelength deviation for each wavelength.

The wavelength deviation Δλₖ may be equal to the difference between two consecutive wavelengths λₖ, λₖ₊₁.

The wavelength deviation Δλₖ may be equal to half the difference between two consecutive wavelengths Δλₖ, Δλₖ₊1.

The wavelength deviation Δλₖ may be equal to a quarter of the difference between two consecutive wavelengths λₖ, λₖ₊1.

The present invention also relates to a method for determining a multispectral filtering array for a sensor, the method comprising:
providing N central wavelengths λ₁, . . . , λₖ, . . . , λ_{N} to be filtered by the filtering array,
determining an elementary pattern of the filtering array in the filtering array,
   the determination of the elementary pattern comprising:
associating an integer e₁, . . . , eₖ, . . . , e_{N} with each central wavelength, each integer being selected so that the product e₁x λ₁, . . . , eₖx λₖ, . . . , e_{N}x λ_{N} of each integer and of the associated central wavelength is substantially constant,
for each central wavelength λₖ, determining eₖ positions of the elementary cell sensitive to said central wavelength λₖ in the elementary pattern so that the ratio between the maximum distance between two closest, or proximal, positions of the elementary cell sensitive to said wavelength and the wavelength associated with said integer is minimal.

The selection of the integers ensuring a substantially constant product between each integer and the associated central wavelength allows statistically uniformizing the transfer function of the image sensor. The proper placement of the eₖ central wavelengths λₖ allows taking into account the optical cutoff frequency and the spatial sampling frequency of the sensor for each wavelength. Thus, the filtering array determined by the method is more reliable and accurate because it takes into account the characteristics of the image sensor.

The filtering array may have dimensions corresponding to a grid of photosites forming the image sensor. The elementary pattern may be repeated in the filtering array.

According to one embodiment, the determination of the eₖ positions of each of the elementary cells sensitive to the N central wavelengths λₖ may comprise determining a cost function ø, said cost function being determined by the following formula:

$$∀ k , ∀ ( {i}_{k} , {j}_{k} ) , ∅ = max [ \frac{{min}_{{i}_{k}} \{ dist ( {i}_{k} , {j}_{k} ) \}}{{λ}_{k}} ] \qquad [ math 1 ]$$

With k an integer comprised between {1, . . . , N}, iₖ, jₖ being integers comprised between {1, . . . , eₖ}, jₖ being different from iₖ, dist(iₖ, jₖ) being the Euclidean distance in the plane between the positions of the iₖ^{th} and jₖ^{th} photosites sensitive to the central wavelength λₖ and minᵢ_{ₖ}{dist(iₖ, jₖ)} being for each position iₖ the minimum distance to all of the positions jₖ, said cost function integrating the repetition of the pattern.

Said distance may be the actual distance between elementary cells.

Hence, the plurality of positions of each elementary cell sensitive to the wavelength may be determined by the positions for which the cost function is the lowest.

Thus, the products eₖx λₖ are considered constant when they meet the following formula:

$$\vert \frac{standard deviation ( {e}_{k} , x {λ}_{k} )}{average ( {e}_{k} x {λ}_{k} )} \vert \leq A \qquad [ math 2 ]$$

A being selected less than or equal to 15% and preferably less than 7%.

Thus, the integers eₖ are selected so as to meet this formula.

The elementary pattern may be a square array. This allows reducing the computing resources necessary to implement the process and simplify manufacturing.

The dimension of the elementary pattern is determined by the following formula:

$${\sum }_{1}^{N} {e}_{k} = {p}^{2} \qquad [ math 3 ]$$

with p being the dimension of the elementary pattern.

The method further comprises: assigning to each position of the elementary pattern a central wavelength associated with the integer arranged at said position of the elementary pattern.

The method may comprise, for one or more position(s) of the elementary pattern, a step of reassigning a first wavelength of the wavelengths by a second different wavelength having a cost function at said position lower than the cost function of the first wavelength at said position.

The predetermined number N of wavelengths is greater than three and is in particular equal to nine.

The present disclosure also relates to a filtering array for a multispectral sensor obtained by the method as mentioned before.

The present disclosure relates to a multispectral sensor comprising a filter corresponding to a filtering array obtained by the aforementioned filtering array determination method.

The present disclosure relates to a device for determining a filtering array for a multispectral sensor including a processing circuit for the implementation of the aforementioned method.

The present disclosure relates to a computer program including instructions for the implementation of the aforementioned filtering array determination method, when said instructions are executed by a processor of a processing circuit.

### BRIEF DESCRIPTION OF THE FIGURES

FIG. 1 shows an embodiment of a method for configuring a multispectral filter,

FIG. 2 shows a filter obtained by the method of FIG. 1, wherein each of the central wavelengths λₖ is represented by its characteristic integer eₖ, each central wavelength λₖ being present eₖ times,

FIG. 3 shows an image capturing device provided with a filter of FIG. 2.

FIG. 4 shows the filter with the central wavelengths λₖ positioned eₖ times, corresponding to the filter of FIG. 2.

### DETAILED DESCRIPTION OF THE INVENTION

The image capturing device 300 of FIG. 4 is configured to provide an image of a scene 302. The image capturing device 300 comprises an optical stage 304 followed by an electronic stage 310. For example, the optical stage 304 comprises an optical objective. The electronics stage 310 comprises an image sensor 308 composed of a plurality of photosites arranged in a grid over the entire surface of the sensor 308. The electronics stage 310 is configured to apply a filter 302 to the image sensor 308.

The electronics stage 310 is also configured to carry out the following steps:

Step 312 of demosaicing, also called debayering, of interpolating of the data detected by the image sensor 308.

Step 314 of processing images from the data interpolated during step 312.

Step 316 of returning a final image representing the scene 302.

For the multispectral imaging system, the sensor 300 is located at the optical focus of these systems, the image formed by the optical stage 304 located upstream of the sensor 300 from the observed scene. The filter 302 is arranged at the image sensor 308.

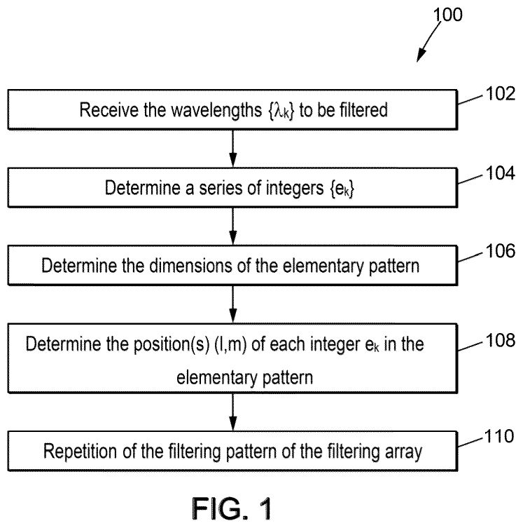

FIG. 1 shows an embodiment of a method for configuring a multispectral filter for an image sensor, for example the filter 302 of the device 300. The image sensor may be a wide spectral band sensor, for example made of Si, InGaAs, InSb, HgCdTe. The image sensor comprises a plurality of photosites arranged in a grid over the entire surface of said sensor.

The method 100 determines a filtering array to be applied to the image sensor. In particular, the method 100 determines an elementary pattern repeated in the filtering array.

The method 100 comprises a step 102 of receiving or determining central wavelengths to be filtered λ₁, . . . , λₖ, . . . , λ_{N}, with k being an integer and N being the number of wavelengths λₖ.

For example, for a sensor made of Si, the wavelengths are comprised between 380 nm and 1,100 nm. In a particular embodiment, the central wavelengths may be {1, 100; 917; 786; 688; 611; 550; 500; 458; 423} nm. In this example, a sensor made of Si or InGaAs is preferred because these materials are photosensitive to the wavelengths of the range of mentioned wavelength values between 423 nm and 1,100 nm.

The central wavelengths may be different by +/−100 nm from the values in the list {1,100; 917; 786; 688; 611; 550; 500; 458; 423} nm. The spectral widths of each of the filters will be at mid-height proportional to a fraction comprised between ¼ and 1 of the deviation between 2 consecutive central wavelengths. Each wavelength varies in an interval defined by a wavelength deviation around said wavelength, the wavelength deviation could be a fraction comprised between 0.25 and 1 of the difference between two consecutive central wavelengths.

Thus, the minimum and maximum limits of the filters could have values from among those of the following table, with an uncertainty of +/−20 nm:

TABLE 1

| | fraction | | | | | |
|---|---|---|---|---|---|---|
| | 0.25 | | 0.5 | | 1 | |
| | Max | Min | Max | Min | Max | Min |
| Wavelength | limit | limit | limit | limit | limit | limit |
| 1,100 | 1,146 | 1,054 | 1,192 | 1,009 | 1,283 | 917 |
| 917 | 956 | 878 | 996 | 839 | 1,074 | 760 |
| 786 | 815 | 757 | 843 | 729 | 901 | 672 |
| 688 | 710 | 666 | 732 | 644 | 776 | 601 |
| 611 | 628 | 594 | 646 | 577 | 680 | 542 |
| 550 | 564 | 536 | 578 | 522 | 606 | 495 |
| 500 | 512 | 489 | 523 | 477 | 546 | 454 |
| 458 | 468 | 448 | 477 | 439 | 497 | 420 |
| 423 | 432 | 414 | 441 | 406 | 458 | 388 |

The method 100 comprises a step 104 of determining a series of integers e₁, . . . , eₖ, . . . , e_{N}.

Each integer eₖ is associated with a central wavelength λₖ. The integers eₖ are determined so that the product e₁x λ₁, . . . , eₖx λₖ, . . . , e_{N}x λ_{N} of each integer eₖ and of the associated wavelength λₖ is substantially constant.

For example, the integers eₖ are determined so as to meet the following formula:

$$\vert \frac{standard deviation ( {e}_{k} , x {λ}_{k} )}{average ( {e}_{k} x {λ}_{k} )} \vert \leq A \qquad [ math 4 ]$$

The value A is selected so as to be less than or equal to 15%. Preferably, the value A is less than 7%. The selection of the integers eₖ allows uniformizing the amount of energy folded back into each central wavelength λₖ. Indeed, for a signal having a bandwidth [0, fc] where fc represents the optical cutoff frequency at 1/(λ*F), F being the aperture number and with a sampling frequency fech, then for the frequencies belonging to [0; fech], the signal is well sampled and will be faithfully reproduced but for the frequencies belonging to [fech; fc], the signal will pass but will not be faithfully reproduced. In the latter case, it will literally be folded back over the correctly reproduced part.

This allows uniformizing, i.e. making as equal/constant as possible, the ratio between the optical cutoff frequency and the spatial sampling frequency fechₖ of the sensor for each wavelength λₖ.

Indeed, the spatial sampling frequency fechₖ of the sensor is on average equal to the inverse of the average distance between the photosites sensitive to the central wavelength λₖ and therefore proportional to the number eₖ of photosites sensitive to λₖ in the elementary pattern. Thus, the uniformization of the optronic chains at the different wavelengths is achieved by a product eₖx λₖ that is as homogeneous as possible, and even constant.

The method 100 comprises a step 106 of determining the dimension of the elementary pattern. For example, the elementary pattern may be square, which simplifies the implementation of the method 100 in terms of necessary computing resources. In this case, step 106 may be carried out by solving the following formula:

$${\sum }_{1}^{N} {e}_{k} = {p}^{2} \qquad [ math 5 ]$$

With p being the dimension of the elementary pattern.

For the following central wavelengths: {1, 100; 917; 786; 688; 611; 550; 500; 458; 423} nm, the series of integers may be {5; 6; 7; 8; 9; 10; 11; 12; 13} and the dimension of the elementary pattern may be 9×9.

Afterwards, the method 100 comprises a step 108 of determining one or more position(s) for each central wavelength λₖ. The central wavelengths are positioned (l, m) in the elementary pattern so that the ratio between the distance at the nearest photosite sensitive to the same central wavelength and the central wavelength is minimum.

Step 108 comprises the minimization of a cost function ø. For this purpose, a cost function ø is determined for each integer eₖ according to the following formula:

$$∀ k , ∀ ( {i}_{k} , {j}_{k} ) , ∅ = max [ \frac{{min}_{{i}_{k}} \{ dist ( {i}_{k} , {j}_{k} ) \}}{{λ}_{k}} ] \qquad [ math 6 ]$$

With k an integer between {1, . . . , N}, iₖ, jₖ being integers comprised between {1, . . . , eₖ}, iₖ being different from jₖ, dist(iₖ, jₖ) being the Euclidean distance in the plane between the positions of the iₖ^{th} and jₖ^{th} photosites sensitive to the central wavelength λₖ and minᵢ_{ₖ}{dist(iₖ, jₖ)} being for each position iₖ the minimum distance to all of the positions jₖ. Thus, a central wavelength λₖ is assigned for each position (l, m) of the elementary pattern.

The distance dist(iₖ, jₖ) may be determined between two positions of photosites sensitive to the central wavelength λₖ within the same elementary pattern or between a first photosite position λₖ in a first elementary pattern and a second photosite position λₖ in a second elementary pattern adjacent to the first elementary pattern. Thus, the cost function ø integrates the repetition of the pattern.

The method 100 may comprise a step of generating the filtering array by repetition of the elementary pattern in the filtering array. The filtering array has dimensions corresponding to the number and distribution of the photosites in the image sensor. Thus, a central wavelength λₖ is assigned to each photosite of the image sensor.

Step 108 may lead to a plurality of distinct elementary patterns. In this case, the method 100 may comprise a step of selecting an elementary pattern among the elementary patterns resulting from step 108. This selection may be random.

The method 100 may comprise a step of optimizing the elementary pattern. This step comprises reassigning a position sensitive to a central wavelength λₖ to a second central wavelength λₖ in the elementary pattern. The elementary pattern after reassignment has a lower cost function than the initial elementary pattern. The reassignments are selected by observation or by combination trial. The integers associated with the central wavelengths then evolve into e′ₖ=eₖ−1 and e′ₕ=eₕ+1.

The optimization step may be carried out several times, for several central wavelengths and several positions.

The method 100 further comprises a step 110 of repeating the pattern determined in the filtering array.

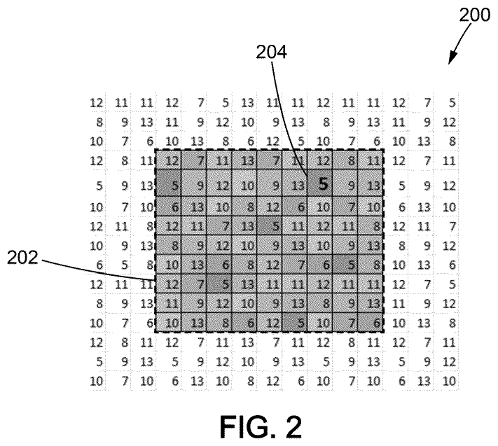

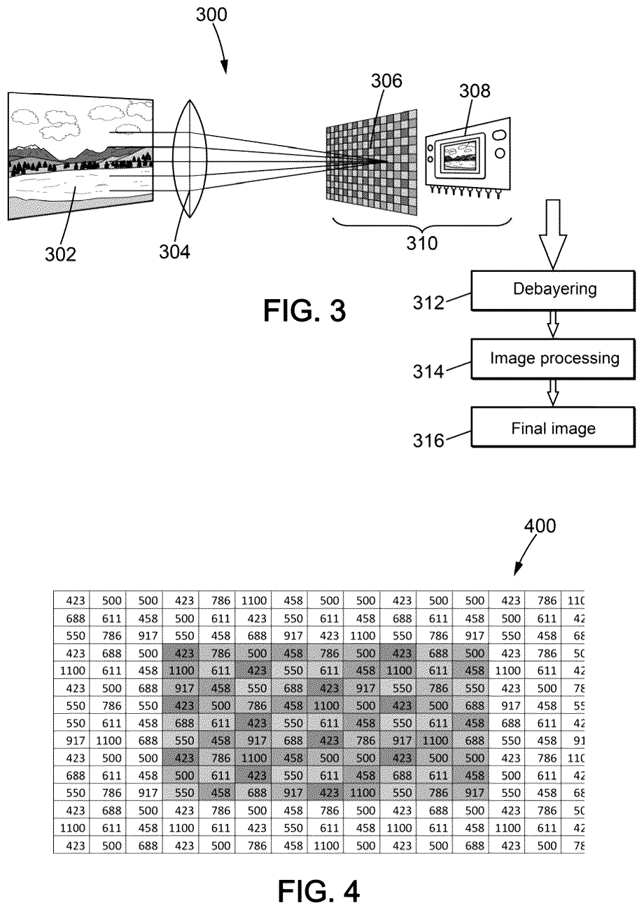

For example, the method may lead to the filtering array 200 shown in FIG. 2 for the series of integers {5; 6; 7; 8; 9; 10; 11; 12; 13} associated with the series of wavelengths {1,100; 917; 786; 688; 611; 550; 500; 458; 423} positioned on the filter of FIG. 4 and leading to the filter 400. The filtering array 200 comprises a plurality of elementary patterns 202 repeated in the filtering array and obtained in step 108. The elementary pattern is repeated in the filtering array in step 110. The integer eₖ arranged at the position 204 of the elementary pattern is replaced by another integer e′ₖ allowing for a lower cost function.

The filtering array 200 obtained by the method 100 is more accurate and more reliable, in particular for a large number of wavelengths, i.e. a number greater than 3. In addition, such a filtering array 200 allows reducing subsequent interpolation errors during image processing because the filtering array takes into account the spatial sampling frequency of the sensor and its optical cutoff frequency.

The wavelengths of the filtering array 400 correspond to the integers of the filtering array 200.

The image sensor may be equipped with the filtering array 200 or the filtering array 400 of FIG. 4 to detect 9 distinct colors corresponding to the wavelengths {1, 100; 917; 786; 688; 611; 550; 500; 458; 423} nm. The image sensor may comprise an image processing module configured to interpolate the data acquired by the image sensor to form an image.

1.-15. (canceled)

16. A multispectral filter for a sensor with an array of elementary sensors, the multispectral filter comprising a filtering array comprising an elementary pattern formed of an arrangement of elementary cells respectively filtering central wavelengths, the number of elementary cells and their position(s) in the elementary pattern being such that:
each central wavelength is associated with an integer, selected so that each product is substantially constant; and
for each value of k between 1 and N, an elementary cell of the elementary cells that filters a central wavelength λₖ is positioned at eₖ positions in the elementary pattern, the eₖ positions being such that the maximum ratio between a distance between two proximal positions of said eₖ positions and an associated central wavelength is minimal.

17. The multispectral filter according to claim 16, comprising the following elementary pattern:
$$\begin{matrix}{λ}_{9} \pm Δ {λ}_{9} & {λ}_{3} \pm Δ {λ}_{3} & {λ}_{6} \pm Δ {λ}_{6} & {λ}_{8} \pm Δ {λ}_{8} & {λ}_{3} \pm Δ {λ}_{3} & {λ}_{7} \pm Δ {λ}_{7} & {λ}_{9} \pm Δ {λ}_{9} & {λ}_{4} \pm Δ {λ}_{4} & {λ}_{7} \pm Δ {λ}_{7} \\ {λ}_{1} \pm Δ {λ}_{1} & {λ}_{5} \pm Δ {λ}_{5} & {λ}_{9} \pm Δ {λ}_{9} & {λ}_{6} \pm Δ {λ}_{6} & {λ}_{5} \pm Δ {λ}_{5} & {λ}_{8} \pm Δ {λ}_{8} & {λ}_{1} \pm Δ {λ}_{1} & {λ}_{5} \pm Δ {λ}_{5} & {λ}_{8} \pm Δ {λ}_{8} \\ {λ}_{2} \pm Δ {λ}_{2} & {λ}_{8} \pm Δ {λ}_{8} & {λ}_{6} \pm Δ {λ}_{6} & {λ}_{4} \pm Δ {λ}_{4} & {λ}_{4} \pm Δ {λ}_{4} & {λ}_{2} \pm Δ {λ}_{2} & {λ}_{6} \pm Δ {λ}_{6} & {λ}_{3} \pm Δ {λ}_{3} & {λ}_{6} \pm Δ {λ}_{6} \\ {λ}_{9} \pm Δ {λ}_{9} & {λ}_{7} \pm Δ {λ}_{7} & {λ}_{3} \pm Δ {λ}_{3} & {λ}_{8} \pm Δ {λ}_{8} & {λ}_{1} \pm Δ {λ}_{1} & {λ}_{7} \pm Δ {λ}_{7} & {λ}_{9} \pm Δ {λ}_{9} & {λ}_{7} \pm Δ {λ}_{7} & {λ}_{4} \pm Δ {λ}_{4} \\ {λ}_{4} \pm Δ {λ}_{4} & {λ}_{5} \pm Δ {λ}_{5} & {λ}_{9} \pm Δ {λ}_{9} & {λ}_{6} \pm Δ {λ}_{6} & {λ}_{5} \pm Δ {λ}_{5} & {λ}_{8} \pm Δ {λ}_{8} & {λ}_{6} \pm Δ {λ}_{6} & {λ}_{5} \pm Δ {λ}_{5} & {λ}_{8} \pm Δ {λ}_{8} \\ {λ}_{6} \pm Δ {λ}_{6} & {λ}_{8} \pm Δ {λ}_{8} & {λ}_{2} \pm Δ {λ}_{2} & {λ}_{4} \pm Δ {λ}_{4} & {λ}_{9} \pm Δ {λ}_{9} & {λ}_{3} \pm Δ {λ}_{3} & {λ}_{2} \pm Δ {λ}_{2} & {λ}_{1} \pm Δ {λ}_{1} & {λ}_{4} \pm Δ {λ}_{4} \\ {λ}_{9} \pm Δ {λ}_{9} & {λ}_{3} \pm Δ {λ}_{3} & {λ}_{1} \pm Δ {λ}_{1} & {λ}_{8} \pm Δ {λ}_{8} & {λ}_{6} \pm Δ {λ}_{6} & {λ}_{7} \pm Δ {λ}_{7} & {λ}_{9} \pm Δ {λ}_{9} & {λ}_{7} \pm Δ {λ}_{7} & {λ}_{7} \pm Δ {λ}_{7} \\ {λ}_{7} \pm Δ {λ}_{7} & {λ}_{5} \pm Δ {λ}_{5} & {λ}_{9} \pm Δ {λ}_{9} & {λ}_{6} \pm Δ {λ}_{6} & {λ}_{5} \pm Δ {λ}_{5} & {λ}_{8} \pm Δ {λ}_{8} & {λ}_{4} \pm Δ {λ}_{4} & {λ}_{5} \pm Δ {λ}_{5} & {λ}_{8} \pm Δ {λ}_{8} \\ {λ}_{6} \pm Δ {λ}_{6} & {λ}_{8} \pm Δ {λ}_{8} & {λ}_{4} \pm Δ {λ}_{4} & {λ}_{2} \pm Δ {λ}_{2} & {λ}_{9} \pm Δ {λ}_{9} & {λ}_{1} \pm Δ {λ}_{1} & {λ}_{6} \pm Δ {λ}_{6} & {λ}_{3} \pm Δ {λ}_{3} & {λ}_{2} \pm Δ {λ}_{2}\end{matrix}$$
where the wavelengths {λ₁-λ₉} are the following series {1,100; 917; 786; 688; 611; 550; 500; 458; 423}, and Δλₖ is a predetermined wavelength deviation for each wavelength.

18. The multispectral filter according to claim 17, wherein the wavelength deviation Δλₖ is equal to a difference between two consecutive wavelengths λₖ, λₖ₊₁.

19. The multispectral filter according to claim 17, wherein the wavelength deviation Δλₖ is equal to half a difference between two consecutive wavelengths λₖ, λₖ₊₁.

20. The multispectral filter according to claim 17, wherein the wavelength deviation Δλₖ is equal to a quarter of a difference between two consecutive wavelengths λₖ, λₖ₊₁.

21. A method for determining a multispectral filtering array for a sensor, the method comprising:
providing N central wavelengths to be filtered by the filtering array;
determining an elementary pattern of elementary cells in the filtering array, by:
associating an integer with each wavelength, each integer being such that all products are substantially equal,
for each central wavelength λₖ, determining eₖ position(s) in the elementary pattern of an elementary cell filtering said central wavelength λₖ so that the maximum ratio between a distance between two proximal positions of said eₖ positions and an associated central wavelength is minimal.

22. The method of claim 21, wherein determining the eₖ positions comprises determining a cost function ø for each central wavelengths, said cost function being determined by the following formula:
$$∀ k , ∀ ( {i}_{k} , {j}_{k} ) , ∅ = max [ \frac{{min}_{ik} \{ dist ( {i}_{k} , {j}_{k} ) \}}{{λ}_{k}} ]$$
where k is an integer between {1, . . . , N}, where iₖ, jₖ are integers belonging to {1, . . . , eₖ}, where jₖ is different from iₖ, where dist(iₖ, jₖ) is the Euclidean distance in the plane of the filter between the positions of the iₖ^{th} and jₖ^{th} photosites sensitive to the central wavelength λₖ and where minᵢ_{ₖ}{dist(iₖ, jₖ)} is, for each position iₖ, the minimum distance to all of the positions jₖ, said cost function integrating a repetition of the pattern,
the plurality of positions of each elementary cell sensitive to the central wavelength λₖ being determined by the positions (l, m) of the elementary pattern for which the cost function is the lowest.

23. The method of claim 21, wherein over k between 1 and N, the products eₖ*λₖ meet the following formula:
$$\vert \frac{standard deviation ( {e}_{k} , x {λ}_{k} )}{average ( {e}_{k} x {λ}_{k} )} \vert \leq A$$
where A is less than or equal to 15% or less than 7%.

24. The method of claim 21, wherein the elementary pattern is a square array.

25. The method of claim 21, wherein the dimension of the elementary pattern is determined by the following formula:
$${\sum }_{1}^{N} {e}_{k} = {p}^{2}$$
where p is the dimension of the elementary pattern.

26. The method of claim 21, wherein the predetermined number N of wavelengths is greater than three.

27. A filtering array for a multispectral sensor obtained by the method according to claim 21.

28. A multispectral sensor equipped with a filter having a filtering array of claim 27.

29. A device for determining a filtering array for a multispectral sensor including a processing circuit for implementing the method of claim 21.

30. A computer program including instructions for the implementation of the method of claim 21 wherein said instructions are executed by a processor of a processing circuit.
